(19) United States
(12) Patent Application Publication
(10) Pub. No.: US 2026/0122311 A1
(43) Pub. Date: Apr. 30, 2026

(54) SYSTEMS AND METHODS FOR INTERACTIVE CONTENT VIEWING AND DISCOVERY

(71) Applicant: RIGH, INC., Palo Alto, CA (US)

(72) Inventors: Richard CHANG, Los Altos Hills, CA (US); Miroslav SAMARDZIJA, Mountain View, CA (US); Xiaowei QIAN, Suzhou (CN); MingShu LIU, Hsinchu City (TW); Cuong VU, Newark, CA (US); Shu-Hsuan YANG, Taoyuan City (TW); Jeffrey CHAO, San Jose, CA (US); Shruti ROYYURU, Mountain View, CA (US); Dinh Hieu Liem VO, San Jose, CA (US)

(21) Appl. No.: 18/951,837

(22) Filed: Nov. 19, 2024

Related U.S. Application Data
(63) Continuation of application No. 18/928,108, filed on Oct. 27, 2024.

(51) Int. Cl. H04N 21/44; H04N 21/81

(52) U.S. Cl. CPC H04N 21/44008; H04N 21/8133

(57) ABSTRACT

Disclosed are computerized systems and methods for a decision intelligence (DI)-based framework that automatically and/or dynamically provides an interactive content viewing and content discovery experience to users. The framework includes functionality for real-time video content analysis and interactive entity identification that, inter alia, provides novel capabilities to viewing users related to the extraction, analysis and subsequent interaction with content depicted within video frames during playback of such content. The framework implements artificial intelligence / machine learning (AI/ML) approaches for video processing, user interaction and information delivery through a series of interconnected processes and subsystems. In some implementations, rendered content can be parsed and mined for real-world and/or digital content depicted therein that relate to real-world entities and/or digital resources, whereby interaction with such entities is provided in the form of a provided interface, electronic message and/or recommendations for further information discovery, or some combination thereof.

### CROSS-REFERENCE TO RELATED APPLICATIONS

This application claims the benefit of priority from U.S. patent application Ser. No. 18/928,108, filed Oct. 27, 2024, which is incorporated herein by reference in its entirety.

### FIELD OF THE DISCLOSURE

The present disclosure provides a decision intelligence (DI)-based computerized framework for automatically and/or dynamically providing an interactive content viewing and content discovery experience.

### SUMMARY OF THE DISCLOSURE

Conventional mechanisms for users to interact with content they are viewing, whether it is being rendered on a television or streamed on their personal device, is to perform a separate search to attempt to discover what content they are viewing. For example, if a user is viewing, on their television, a scene from a movie, and in the scene, there is a sports car, if the user desires to understand more about that car, the user must perform a manual search based on a guess as to what the car was from the content they were capable of viewing. In some instances, the user can take a picture and submit such picture to a search engine to perform an image search. This, however, is not only cumbersome and inefficient, but is prone to inaccuracies. Moreover, such conventional mechanisms available to modern users does not provide such users to the complex data that is being relayed in such scenes (e.g., the data/metadata related to the scene frames, content file, among others).

To that end, according to some embodiments, disclosed are systems and methods that provide a novel, computerized framework for real-time video content analysis and interactive entity identification. According to some embodiments, as discussed herein, the disclosed framework provides comprehensive capabilities that enables users to extract, analyze and interact with content from video frames directly from, and during such video playback. As discussed herein, the disclosed framework can operate/function on various platforms including, but not limited to, set top boxes (STBs), smart televisions (TVs), mobile devices, gaming consoles, computers, and other video playback devices that support user interaction through multiple input modalities.

According to some embodiments, as provided in more detail below, the disclosed framework can function to continuously monitor an active video stream, while simultaneously maintaining a buffer of recent frames to ensure seamless capture capabilities without interrupting the viewing experience. In some embodiments, for example, the video stream may be sourced from local storage, streaming services, live broadcasts, real-time camera feeds, and the like, or some combination thereof. In some embodiments, the framework can implement a low-latency capture system that can instantly respond to user inputs while maintaining synchronization with the video playback.

According to some embodiments, as provided in more detail below, the disclosed framework can function to receive, accept or otherwise identify diverse input methods to trigger frame capture and analysis. Such input methods can include, but are not limited to, voice commands (e.g., “identify this scene”, “who is that person,” “capture this moment,” “‘snap’” “‘snap’ now,” “share with Jane,” and the like), physical controller inputs (e.g., pressing a designated button or performing a specific gesture), touch screen interactions (such as tapping or holding on an area of interest, which can be input on the device rendering the content and/or via an application associated with and/or paired with the disclosed framework functioning in relation to the TV (e.g., on a smart phone that sends instructions to an STB or TV to capture a specific frame or set of frames), automated triggers based on predefined rules, dynamically determined context, behavior patterns, content recognition, and the like. In some embodiments, the framework can process multiple simultaneous input methods, allowing users to combine different interaction modes for more precise control over the analysis process. In some embodiments, an input may include an indication to capture a set of frames (e.g., depress a button on a remote controller for a period of time that correlates to a number of frames in the video).

In some embodiments, upon receiving a trigger input, the framework can function to capture a frame(s) from the video stream. As discussed herein, such capture process can include a single frame at the exact moment of input, or in some embodiments, a sequence of frames spanning a configurable duration before and after the trigger point. In some embodiments, the framework can employ advanced frame selection algorithms to identify the most suitable frames for analysis, considering factors such as, but not limited to, frame rate, image quality, motion blur, the presence of identifiable elements, and the like, or some combination thereof.

According to some embodiments, the captured frames undergo a multi-stage analysis process utilizing any type of known or to be known artificial intelligence and/or machine learning (AI/ML) (e.g., computer vision) and/or large language model (LLM) techniques, as discussed in more detail below. For example, an initial stage of such analysis can involve implementing object detection and segmentation algorithms to identify distinct entities within the frame. Such algorithms function to partition the frame into regions of interest and classify elements into categories such as, for example, people, buildings, consumer products, landmarks, text, and other relevant objects/items. In some embodiments, the framework can maintain and implement a hierarchical classification system that can identify both broad categories and specific instances within those categories.

In some embodiments, the framework can implement facial recognition capabilities to identify individuals within the captured frames. Such facial recognition mechanisms can interface with multiple databases, including public figure databases, user-defined contact lists, and social media platforms (with appropriate permissions and privacy controls). In some embodiments, the framework can function to recognize not only faces, but also distinctive features, such as, but not limited to, clothing styles, accessories, and contextual elements that aid in person identification, as well as the identification of such items, as discussed infra.

In some embodiments, the framework can incorporate location and landmark recognition capabilities, which can include, but are not limited to, identification of geographic locations, architectural landmarks, natural features, and other place-specific elements. In some embodiments, for example, the framework can utilize multiple reference databases, including geographic information systems, architectural databases and user-contributed location data. In some embodiments, the framework can correlate recognized locations with additional contextual information such as historical significance, current events, or related points of interest.

In some embodiments, the framework can implement object recognition capabilities that extend beyond simple classification to include specific product identification, brand recognition, and detailed item characteristics. Such functionality, for example, can include the ability to identify consumer products, artwork, vehicles, technology devices and other distinguishable items. In some embodiments, the framework can maintain connections to product databases, enabling it to provide detailed information about recognized items, including network locations (e.g., URLs and/or marketplaces), specifications, pricing, availability, and the like.

In some embodiments, the framework can implement advanced context analysis algorithms that consider the relationships between identified entities within the frame. For example, such functionality can include, but is not limited to, spatial relationships, interaction patterns, temporal context from surrounding frames, and the like. Such context analysis enhances the accuracy of entity identification and enables the disclosed systems and methods to provide more meaningful insights about the scene composition and the relationships between identified elements.

In some embodiments, the framework can utilize (e.g., generate, in some embodiments) rich metadata for each identified entity, including confidence scores, alternative identifications, relationships to other entities, and the like. Such metadata can include, but is not limited to, temporal information (e.g., timestamp within the video), spatial information (e.g., location within the frame), contextual information (e.g., relationship to other identified entities or broader scene context), and the like. In some embodiments, the framework can maintain and/or provide such metadata in a structured format that facilitates efficient searching, filtering and organization of identified entities across multiple frames or videos.

Accordingly, in some embodiments, the framework can utilize such processing of identified information, discussed above and in more detail below, to present the information in a compiled, easily digestible manner to users through a flexible and configurable user interface (UI). In some embodiments, such UI can involve an overlay of information directly on the video playback, displaying it in a separate panel or window, presented/communicated through other output modalities such as, but not limited to, voice synthesis or haptic feedback. In some embodiments, such interface implements multiple visualization modes, allowing users to choose between detailed technical information, simplified summaries, or interactive exploration options.

In some embodiments, the compiled and provided information to the user, which includes information related to the real-world entities (RWEs) and/or digit entities within such frame(s) (e.g., people, place, things/items, for example), can be provided as, but not limited to, an electronic message (SMS message, in-app notification, email to an account), as a UI, augmented reality (AR) display, virtual reality (VR) display, extended reality (XR) display, and the like, or some combination thereof, as discussed supra.

In some embodiments, the framework can generate interactive elements (e.g., interface objects (IOs), uniform resource locators (URLs), selectable icons, deep-linking content, and the like) for each identified entity, enabling users to access additional information and related content. Such interactive elements may take the form of clickable overlays, hyperlinks, or interactive markers within the user interface. In some embodiments, the interactive elements can be configured context-aware, providing different options and information based on the type of entity, user preferences, and current application context.

In some embodiments, the framework can provide a comprehensive linking functionality that connects identified entities to various sources of supplemental content. In some embodiments, by way of example, for people, this can include social media profiles, biographical information, filmographies, contact information (e.g., where applicable and permitted), and the like. For locations, for example links may lead to maps, travel information, historical data, or related attractions. For products, for example links may connect to purchasing options, reviews, specifications, related items, promotional materials, and the like. In some embodiments, such linking functionality can be extensible, allowing for the integration of additional content sources and types of supplemental information.

In some embodiments, the framework can implement caching and persistence functionality that stores analysis results and generated metadata for future reference. Such functionality can enable quick access to previously identified entities and their associated information, reducing the need for repeated analysis of the same content. In some embodiments, such caching operations can involve intelligent prefetching mechanisms that anticipate user interests based on viewing patterns and interaction history.

In some embodiments, the framework can include privacy controls that allow users to configure the types of analysis performed and the information displayed. such controls can include options to disable certain types of recognition (e.g., such as facial recognition), limit the storage of analysis results, restrict the types of supplemental content that can be accessed, and the like. In some embodiments, the privacy controls integrate with platform-level security settings and user preferences to ensure consistent privacy protection across different usage contexts.

In some embodiments, the framework can incorporate and/or include collaborative features that enable multiple users to share and discuss identified entities and their associated information. For example, this can include, but is not limited to, capabilities for sharing analysis results, annotating identified entities with comments or tags, participating in discussions about specific elements within the video content, and the like. In some embodiments, such collaborative features can be implemented via access controls and permission systems to manage information sharing and interaction capabilities among different users or user groups.

In some embodiments, the framework can include analytics functionality that tracks user interactions with identified entities and their associated supplemental content. Such functionality can involve operations to, but not limited to, collecting data/metadata related to which entities users find most interesting, which types of supplemental content are most frequently accessed, how users interact with different aspects of the interface, and the like. In some embodiments, such analytics can inform improvements to the recognition algorithms, interface design and content linking strategies, and the like, as discussed herein.

In some embodiments, the framework can implement an extensible plugin architecture that enables the integration of additional recognition capabilities, content sources, interaction mechanisms, and the like. Such architecture can be configured to evolve with advancing technology and changing user needs, incorporating new types of entity recognition, additional sources of supplemental content, and novel interaction paradigms. In some embodiments, such functionality can include, but is not limited to, validation and security measures to ensure the integrity and reliability of extended functionality.

According to some embodiments, a method is disclosed for automatically and/or dynamically providing an interactive content viewing and content discovery experience. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for automatically and/or dynamically providing an interactive content viewing and content discovery experience.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 illustrates an exemplary workflow according to some embodiments of the present disclosure;

FIG. 5 illustrates an exemplary workflow according to some embodiments of the present disclosure;

FIG. 6 illustrates an exemplary workflow according to some embodiments of the present disclosure;

FIG. 7 illustrates an exemplary workflow according to some embodiments of the present disclosure;

FIG. 8 depicts an exemplary implementation of an architecture according to some embodiments of the present disclosure;

FIG. 9 depicts an exemplary implementation of an architecture according to some embodiments of the present disclosure; and

FIG. 10 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub- networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2^{nd}, 3^{rd}, 4^{th} or 5^{th} generation (2G, 3G, 4G or 5G) cellular technology, mobile edge computing (MEC), Bluetooth, 802.11b/a/g/n/ac/ax/be, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, disclosed is a computerized framework for real-time video content analysis and interactive entity identification that, among other features, provides novel capabilities to viewing users related to the extraction, analysis and subsequent interaction with content depicted within video frames during playback of such content. As discussed herein, the framework implements artificial intelligence / machine learning (AI/ML) approaches for video processing, user interaction, and information delivery through a series of interconnected processes and subsystems. As provided herein, rendered content can be parsed and mined for real-world and/or digital content depicted therein that relate to real-world entities and/or digital resources, whereby interaction with such entities is provided in the form of a provided interface, electronic message and/or recommendations for further information discovery, or some combination thereof.

As discussed in more detail below, the disclosed framework functions to provide users with curated content to enhance their viewing experience, while availing such users to the discovery of entity information in a manner that was previously unavailable prior to the advent of the instant disclosures systems and methods. The framework can provide recommendations, network resources and overall opportunities for users to obtain the entities depicted in such viewed frames (e.g., see a car on the screen, and be provided with a link that enables the purchase of that car, for example). The framework provides such capabilities while ensuring responsive performance and seamless user experience across various platforms and devices.

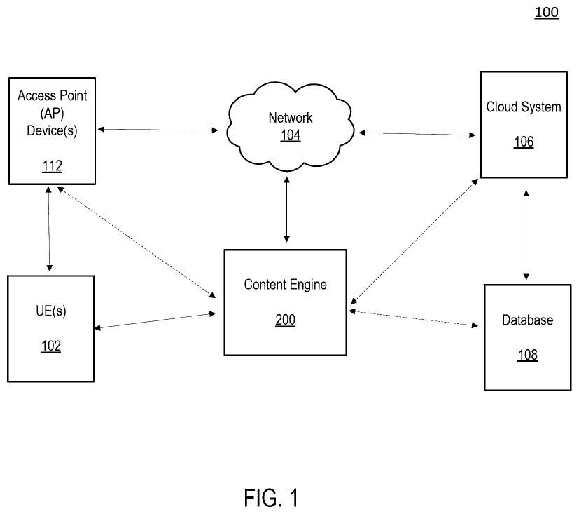

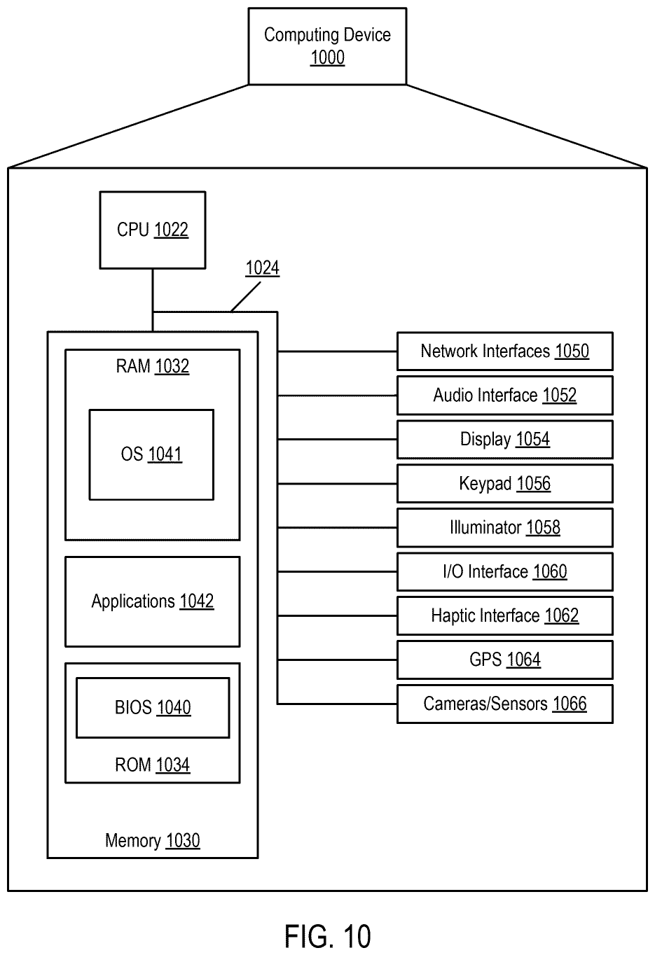

With reference to FIG. 1, system 100 is depicted which includes user equipment (UE) 102 (e.g., a client device, as mentioned above and discussed below in relation to FIG. 10), AP device 112, network 104, cloud system 106, database 108 and content engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1A.

According to some embodiments, UE 102 can be any type of device, such as, but not limited to, a mobile phone, tablet, laptop, sensor, Internet of Things (IoT) device, wearable device, autonomous machine, smart television, set top box (STB), media streaming device, game console, and any other device equipped with a cellular or wireless or wired transceiver.

In some embodiments, UE 102 can be a smart device of a user. In some embodiments, by way of a non-limiting example, as provided herein, UE 102 can be a STB that is paired with/connected to a television. In another non-limiting example, UE 102 can be a smart television. Thus, in some embodiments, system 100 can include multiple UEs 102, whereby a first UE can be a STB connected to another UE 102 that is a television, and the viewing user can have their own UE 102 which is their smart phone.

In some embodiments, peripheral devices (not shown) can be connected to UE 102, and can be any type of peripheral device, such as, but not limited to, a wearable device (e.g., smart ring, smart watch, for example), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, UE 102 can include and/or correspond to, but not be limited to, any type of device, component and/or sensor associated with a location of system 100 (referred to, collectively, as “sensors”). In some embodiments, the UE 102 can be any type of device that is capable of sensing and capturing data/metadata related to activity of the location. In some embodiments, the sensors can be associated with devices associated with the location of system 100, such as, for example, STBs, access point devices, televisions, personal assistants (e.g., Alexa®, Nest®, for example)), smart phones, smart watches or other wearables, tablets, personal computers, and the like, and some combination thereof. In some embodiments, UE 102 can be associated with any device connected and/or operating on cloud system 106 (e.g., a cloud-based device, such as a server that collects information related to the location, for example).

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a service provider, content provider, internet service provider ISP), communication service provider (CSP), and the like, which has associated network resources hosted on the internet or private network (e.g., network 104), which enables (via engine 200) the content management and delivery discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, and the services and applications provided by cloud system 106 and/or content engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

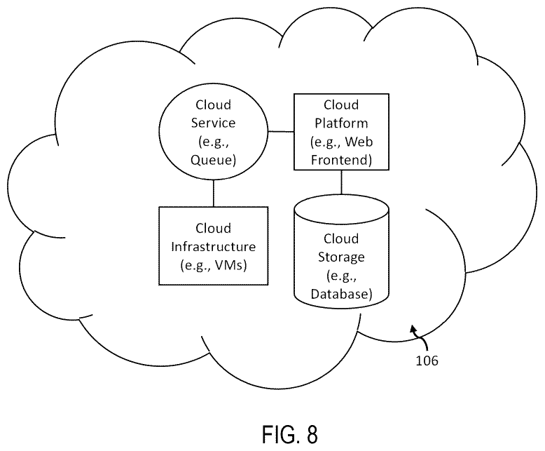

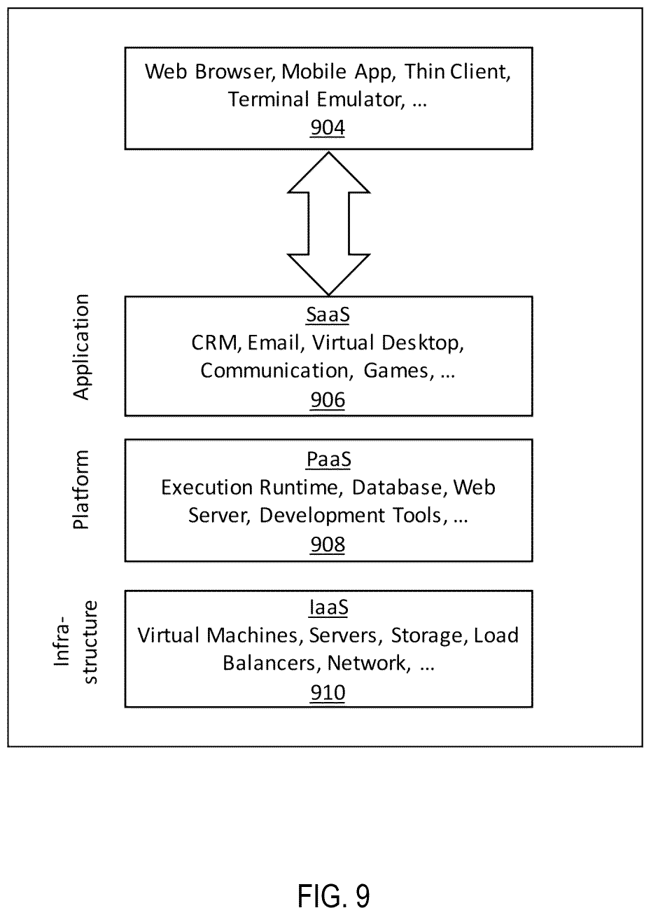

Turning to FIGS. 8 and 9, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 910, platform as a service (PaaS) 908, and/or software as a service (SaaS) 906 using a web browser, mobile app, thin client, terminal emulator or other endpoint 904. FIGS. 8 and 9 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, structured query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Content engine 200, as discussed above and further below in more detail, can include components for the disclosed functionality. According to some embodiments, content engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

By way of non-limiting example, engine 200 can function within UE 102, which as discussed above and in more detail below, can be a STB and/or smart television, for example. In another non-limiting example embodiment, engine 200 can function via a smart phone of a user, as an application for which the user can interact with a STB and/or smart television.

According to some embodiments, as discussed in more detail below, content engine 200 may be configured to implement and/or control a plurality of services and/or microservices, where each of the plurality of services/microservices are configured to execute a plurality of workflows associated with performing the disclosed network management. Non-limiting embodiments of such workflows are discussed and provided below.

According to some embodiments, as discussed above, content engine 200 may function as an application provided by a content and/or service provider and/or cloud system 106. In some embodiments, engine 200 may function as an application installed on a server(s), network location and/or other type of network resource associated with system 106. In some embodiments, engine 200 may function as an application installed and/or executing on AP device 112 and/or UE 102. In some embodiments, such application may be a web-based application accessed by AP device 112 and/or UE 102, and/or devices accessible over network 104 from cloud system 106. In some embodiments, engine 200 may be configured and/or installed as an augmenting script, program or application (e.g., a plug-in or extension) to another application or program provided by cloud system 106 and/or executing on AP device 112 and/or UE 102. Accordingly, as provided below, engine 200 can execute on a device, at a network location, on nodes of a network and/or across a network, on differing components to perform the operations of each module executing therein.

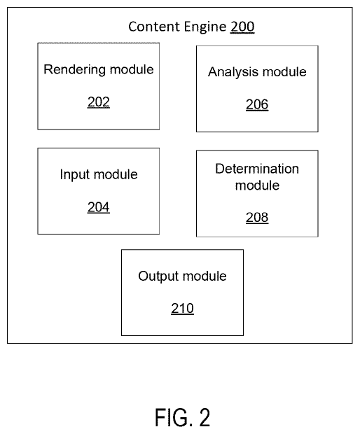

As illustrated in FIG. 2, according to some embodiments, content engine 200 includes rendering module 202, input module 204, analysis module 206, determination module 208 and output module 210. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

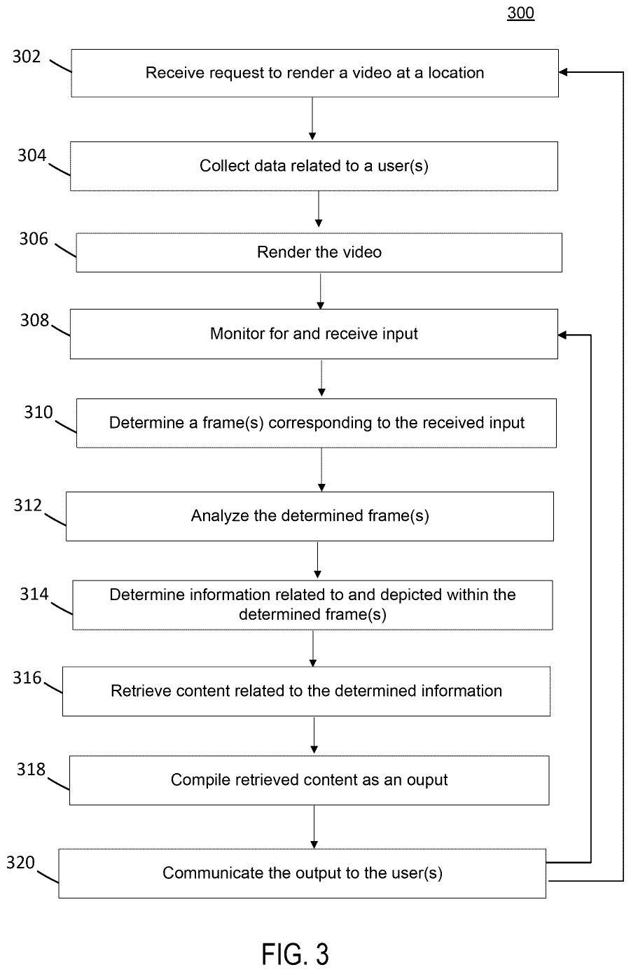

Turning to FIGS. 3-7, Processes 300-700 provides non-limiting example embodiments for the disclosed content management and delivery framework. As discussed herein, the disclosed systems and methods provide a computerized video analysis and entity identification framework (e.g., engine 200, as discussed infra in relation to the steps of Processes 300-700) that operates through consumer electronics devices—for example, STBs and smart TVs. The disclosed implementations are configured to seamlessly integrate with existing viewing habits while creating new opportunities for user engagement and monetization through strategic partnerships and content linking.

According to some embodiments, the framework can leverage set top box hardware through a dedicated system-on-chip (SoC) architecture that simultaneously manages traditional video processing and advanced entity recognition capabilities. In some embodiments, such STB implementation can integrate with existing cable, satellite, on-demand and/or streaming services while maintaining an overlay layer for entity identification and interaction. In some embodiments, the framework can establish and maintain a persistent connection to cloud-based processing services, enabling the delegation of computationally intensive tasks such as deep learning-based entity recognition and information retrieval to more powerful remote systems.

In some embodiments, the hardware architecture within the STB encompasses specialized components working in concert to deliver the framework's capabilities. A dedicated image processing unit continuously analyzes the video stream in real-time, capturing and preprocessing frames for entity recognition. Local storage systems cache frequently accessed content and user data, reducing latency and bandwidth requirements while improving response times for common queries. Multiple network interfaces operate simultaneously, allowing the system to maintain stable video streaming while conducting background data retrieval and analysis tasks.

In some embodiments, an STB implementation can extend existing remote control functionality through sophisticated input mapping and interpretation systems. The framework can function to interpret sustained button presses as distinct commands from quick presses, enabling expanded functionality without requiring new hardware. For example, when a user holds the pause button, the system initiates frame capture and analysis, while maintaining traditional pause functionality for quick presses. The directional pad takes on contextual meaning when interacting with identified entities, allowing users to navigate through recognition results and related content using familiar button patterns.

In some embodiments, the framework can integrate directly into smart TV operating systems, leveraging native processing capabilities and network connectivity to deliver enhanced functionality without requiring additional hardware. Such integration taps into the TV's existing image processing pipeline, enabling high-fidelity frame capture and analysis without introducing additional processing overhead or latency. In some embodiments, the framework can function to utilize built-in cameras and sensors to detect viewer presence and attention, adjusting its behavior based on the viewing context and audience engagement levels.

In some embodiments, a UI in such smart TV implementations can maintain consistency with the TV's existing design language while introducing new interactive elements. The framework can transition between passive viewing and interactive modes, using subtle visual cues to indicate when entity recognition is available or active. Such integration can extend to the TV's existing menu systems and settings interfaces, allowing users to configure the framework's behavior through familiar control schemes and navigation patterns.

In some embodiments, the framework can implement multiple interaction methodologies that adapt to different viewing scenarios and user preferences. As discussed above, in some embodiments, voice command mechanisms can employ natural language processing (NLP to interpret conversational inputs, understanding context and intent rather than requiring specific command phrases. The framework can process multiple languages and dialects, maintaining accuracy through machine learning models trained on diverse speech patterns and accents. Accordingly, voice-based navigation allows users to explore identified entities and related content through natural conversation, with the framework maintaining context across multiple interactions.

In some embodiments, remote control integration can extend beyond basic button mapping to create intuitive interaction patterns. In some embodiments, the framework can track button press patterns and timing to differentiate between casual viewing interactions and intentional framework engagement. For example, in some embodiments, context-sensitive button mappings can change based on the current operation mode, displayed content, and recent user actions. In some embodiments, the framework can implement precise on-screen cursor control through accelerometer-based motion detection or traditional directional pad input, allowing users to select specific areas of interest within frames.

In some embodiments, mobile device integration can create a complementary experience through companion applications that extend the framework's capabilities. Such applications can provide detailed information about identified entities while maintaining synchronization with the main viewing experience. Touch-based interactions on mobile devices can offer precise control over entity selection and information navigation, while social sharing features enable immediate content distribution through multiple platforms and communication channels.

In some embodiments, the framework can implement comprehensive monetization strategies that generate value for multiple stakeholders while maintaining focus on user experience quality. In some embodiments, as provided below, the framework can create revenue opportunities through sophisticated product recognition and commerce integration systems that connect viewers with purchasing opportunities while preserving viewing immersion.

According to some embodiments, the framework can establish and maintain, and/or be based on, strategic partnerships with retailers, brands and e-commerce platforms to monetize product identification within video content. For example, when the framework identifies products within frames, multiple parallel processes can be initiated to generate revenue while providing value to partners. For example, commission-based affiliate linking systems can be utilized to track user engagement and purchases, ensuring fair compensation for all participating entities. And, in some embodiments, premium placement algorithms can be leveraged by the framework to determine optimal positioning and presentation of retailer information based on factors including commission rates, user preferences, and historical performance metrics. For example, ads can be displayed within a provided UI of entity information from a video frame, as an advertisement within a television program, annotated to a shared message, inserted within the video frame, and the like, or some combination thereof.

In some embodiments, the framework can provide partners with real-time analytics describing viewer engagement patterns and product interest levels. These metrics can include, but are not limited to, detailed attention measurements, occupancy detection, interaction rates, conversion tracking across multiple channels and platforms, and the like. The framework can function to correlate viewer demographic data and user behavior patterns (among other user related data (e.g., context, for example)) with product interest patterns, enabling partners to optimize their offerings and marketing strategies based on actual viewer behavior and preferences.

In some embodiments, the framework can implement sophisticated location-aware features that connect viewers with nearby retail opportunities (e.g., to provide links or directions to local stores rather than big box stores that are not close to the consumer/user, for example). Accordingly, in some embodiments, real-time inventory management systems can be utilized to interface the framework with local retailers'stock databases, providing accurate availability information and pricing details for identified products. Thus, in some embodiments, the framework generates dynamic routing information to guide viewers to nearby stores, including operating hours, contact information, and special offers specific to physical locations.

In some embodiments, the framework can create monetization opportunities through deep integration with social media platforms and content sharing networks. The framework can function to identify and link to relevant influencer content featuring recognized products, creating additional revenue streams through commission-based partnership programs. For example, in some embodiments, the framework can utilize viral content integration algorithms to identify trending social media posts related to recognized entities, enabling immediate connection to popular conversations and content streams.

In some embodiments, the framework can track, compile and maintain detailed metrics regarding social engagement patterns and content effectiveness, thereby providing valuable insights to partners while enabling performance-based pricing models for social integrations. In some embodiments, the framework can implement sophisticated content matching algorithms that identify relationships between broadcast content, social media activity and viewer interests, thereby enabling targeted content distribution and engagement opportunities.

According to some embodiments, the framework can be configured to support advanced advertising integration through context-aware ad placement and dynamic content delivery systems. In some embodiments, the framework can analyze scene content, viewer engagement patterns, historical performance data, and the like, or some combination thereof, to determine optimal moments for ad insertion. Real-time pricing engines adjust offer values based on current market conditions, inventory levels, and viewer interest patterns.

Accordingly, in some embodiments, the framework can leverage dynamic ad content mechanisms that can modify the provided outputs to the users (e.g., recommendations, the UI, messages, app notifications, for example) based on multiple factors including viewer location, time of day, recent interaction patterns, and the like. Thus, the framework can maintain synchronization between traditional broadcast advertisements and enhanced interactive features, thereby creating seamless transitions between standard commercial content and framework-enabled engagement opportunities.

Thus, as discussed herein, through the implementation and usage of sophisticated implementation and monetization strategies, the framework can create sustainable value while maintaining focus on user experience quality (e.g., balancing and integrating business opportunities with the advanced technology solutions provided herein).

FIG. 3 provides Process 300, for which an overall workflow is provided for rendering content, capturing entity information from such rendering, and providing additional/supplemental content to users for which they can further engage.

According to some embodiments, Steps 302-306 of Process 300 can be performed by rendering module 202 of content engine 200; Steps 308-310 can be performed by input module 204; Step 312 can be performed by analysis module 206; Steps 314 and 316 can be performed by determination module 208; and Steps 318 and 320 can be performed by output module 210.

According to some embodiments, Process 300 begins with Step 302 where engine 200 can receive a request to render a video (or video content, used interchangeably) at a location. For example, a user can select a television show to play on their TV, which can be selected via any mechanism for which media content can be rendered on a television (e.g., selection from an electronic program guide (EPG), casting or streaming from a device, and the like).

According to some embodiments, such request can originate from various sources, including but not limited to, user applications, streaming platforms, broadcast systems, automated scheduling systems, and the like. Accordingly, in some embodiments, the video content can be sourced from local storage, cloud-based services, live broadcasts, real-time feeds, and the like. In some embodiments, engine 200 can validate the video source and prepare appropriate buffering and processing resources based on the content type and delivery method.

It should be understood that while the discussion herein may focus on rendering a television show on a television in a user's home, it should not be construed as limiting, as one of ordinary skill in the art would readily understand that any type of renderable content via any type of device can form the basis for the disclosed operations of the instant systems and methods without departing from the scope of the instant disclosure.

In Step 304, upon reception of the rendering request, engine 200 can collect data related to a user or users. For example, such user(s) can include, but is not limited to, the user providing the request, users in the same room, users proximate (e.g., within a threshold distance to the television, for example), users engaged with the television (e.g., their attention is on the television and not on their devices (e.g., they are not scrolling or interacting at a current time the request is received, for example)), and the like, or some combination thereof.

Thus, for example, Step 304 can identify that user Bob provided the request to watch the television show on the living room TV, and his daughter is sitting next to him watching the TV as well, but his wife, sitting behind him on another couch, is not watching the TV given her position and/or her current engagement in watching TikTok™ videos on her phone.

Accordingly, in some embodiments, before initiating video playback, engine 200 can engage in comprehensive data collection regarding the user or users who will be viewing the content. In some embodiments, such collection process includes multiple components designed to understand the viewing context and user preferences. In some embodiments, engine 200 can employ advanced occupancy sensing technologies to detect and track the presence of viewers in the viewing area. Such technologies may include but are not limited to computer vision systems, infrared sensors, radar-based presence detection, integration with smart home occupancy systems, and the like.

In some embodiments, engine 200 can further or alternatively leverage network data to determine which users are currently watching the television. For example, which devices are actively communicating a threshold satisfying amount of network content (e.g., scrolling in an application, viewing content, and the like), as discussed above.

In some embodiments, engine 200 can generate and maintain precision profiles for each user (e.g., resident users of a location, or users, in general, having an account with a provider of the disclosed framework and/or a specific network provider (e.g., ISP/CSP account), for example. Such profiles can encompass various aspects of user data, including, but not limited to, user behavior, preferences and interaction patterns, as well as, but not limited to, user identifier (ID), demographics, biometrics, geography, historical viewing patterns, previous entity identification requests, frequently accessed supplemental content types, preferred interaction methods, and the like. In some embodiments, the profiles can be dynamically updated based on monitored user interactions and behavior patterns, enabling increasingly accurate personalization of the framework's operations.

Accordingly, in Step 304, engine 200 can detect users engaged with the device for which the requested video is to be rendered, as well as their corresponding user data from their respective precision profile.

In Step 306, engine 200, in response to the request from Step 302, can execute operations to cause rendering of the video content on the television. And, in Step 308, upon commencing rendering of the video, engine 200 can monitor for input from a user, whereby as discussed above, such input corresponds to a capture of a frame or frames of the video for which content discovery can be performed.

Accordingly, respective to the video playback and input monitoring operations of Steps 306 and 308, engine 200 can begin rendering the video content while simultaneously maintaining active monitoring systems for user input. In some embodiments, such rendering process can implement adaptive quality control mechanisms that optimize playback based on available system resources and network conditions. In some embodiments, engine 200 can maintain a configurable buffer of recent frames to enable instant response to user inputs without interrupting the viewing experience.

In some embodiments, engine 200 can implement sophisticated input monitoring functionality that can process multiple input types simultaneously. As discussed above, engine 200 can detect and accept inputs through various modalities, including, but not limited to, voice commands (such as “identify this scene” or “share this with Bob”), physical controller inputs (such as, button presses or gesture controls), touch screen interactions (such as, taps or swipes), and/or other types of known or to be known inputs and/or input mechanisms. In some embodiments, the input processing functionality deployed by engine 200 can include LLM functionality, such that natural language understanding capabilities can be utilized to interpret complex and/or conversational input commands.

In some embodiments, engine 200 can utilize automatic input triggering based on user data and behavioral analysis. For example, this can involve engine 200 performing operations that are based on triggers based on detected viewing patterns, such as increased attention to particular scenes or repeated viewing of specific segments. Such automatic triggering functionality can also respond to environmental factors, such as changes in viewer occupancy or detected conversations about the content. In some embodiments, engine 200 can implement AI/ML algorithms that continuously refine the automatic triggering criteria based on user responses and interaction patterns.

In Step 310, engine 200 can determine (or identify) a frame(s) that corresponds to the received input. According to some embodiments, such frame identification can involve, upon receiving input (either manual or automatic), engine 200 can implement frame identification processing that, among other features, determines which frame or sequence of frames should be analyzed based on the input context and timing. For example, for manual inputs, engine 200 can capture the exact frame at the moment of input or a configurable sequence of frames surrounding the input timestamp. In some embodiments, for automatic triggers, engine 200 can implement intelligent frame selection algorithms that identify the most relevant frames based on content analysis and user interest patterns.

In some embodiments, such frame(s) along with the information related to the input can be stored in database 108, as discussed above.

In Step 312, engine 200 can analyze the determined frame(s) from Step 310. That is, in some embodiments, the selected frames undergo comprehensive analysis by engine 200 utilizing AI/ML and/or LLM techniques. By way of example, in some embodiments, engine 200 can execute an analysis process that includes multiple stages, beginning with basic image processing and enhancement to ensure optimal quality for entity recognition. Engine 200 can then apply advanced object detection and segmentation algorithms to identify distinct elements within the frame. In some embodiments, the analysis mechanism can implement parallel processing capabilities to simultaneously evaluate multiple aspects of the frame content.

Accordingly, in some embodiments, the analysis of Step 312 can involve engine 200 implementing any type of known or to be known computational analysis technique, algorithm, mechanism or technology to analyze the determined frame(s) (and the corresponding information, data and metadata related to such frame(s) and/or the source video content).

In some embodiments, engine 200 may include a specific trained AI/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may leverage a LLM(s), whether known or to be known. As discussed herein, an LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the user data, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 314, based on the analysis from Step 312, engine 200 can determine information related to and depicted within the determined frames.

By way of a non-limiting example, engine 200 can be rendering a movie with an actor driving a motorcycle over a bridge in San Francisco, and in Step 314, engine 200 can determine that the actor is Tom Cruise, the motorcycle is a Honda CRF250, and the bridge is the Golden Gate Bridge. Such information corresponds to real world entity (RWE) entities.

In another non-limiting example, a television show can depict a person typing on a computer screen. In Step 314, engine 200 can determine the actor's identity, the make and model of the computer, and the network location (e.g., URL or application) depicted on the screen of the computer. Thus, RWE information and digital information can be determined.

Accordingly, engine 200 can implement entity (RWE and/or digital) recognition functionality that can identify and classify various elements within the analyzed frames. The recognition functionality can categorize entities into primary categories including people, places, and things (or items), with each category having multiple subcategories and specific instance recognition capabilities. In some embodiments, engine 200 can generate and/or maintain hierarchical classification structures that enable both broad categorization and specific instance identification.

Accordingly, engine 200's recognition capabilities, via the analysis in Step 312 discussed supra, can include, but are not limited to, advanced facial recognition techniques (e.g., computer vision, for example) for identifying individuals, landmark recognition for identifying locations and places, and object recognition for identifying products, vehicles, architecture, and other physical items. The recognition functionality may employ multiple specialized neural networks optimized for different types of entity recognition. In some embodiments, engine 200 can also analyze, via the AI/ML model execution discussed above, relationships between identified entities to establish context and improve recognition accuracy.

In some embodiments, the determined information can be stored in database 108, as discussed above.

In Step 316, engine 200 can compile a search query based on the determined information (and, in some embodiments, the user data from Step 304), and perform a search and retrieve content related to the determined information. According to some embodiments, such network search and information retrieval can involve engine 200 executing a comprehensive network search(es) to gather relevant information about the identified entities. In some embodiments, such search process can be dynamically compiled based on multiple factors including, but not limited to, user data, behavioral patterns, input context, context of the entities, and the like, or some combination thereof. In some embodiments, the search parameters of the query can be automatically adjusted based on the type of entity identified and the detected user interest patterns, among other types of information.

In some embodiments, engine 200 can implement a contextual search optimization that considers various factors including, but not limited to, the timing and nature of the input trigger (e.g., why the frame was captured), the content context surrounding the identified frame (e.g., what was happening in the video), the temporal context of the capture (e.g., when the frame was captured), the user's location and viewing environment (e.g., where the capture occurred), the user's historical interaction patterns and preferences, and the like, or some combination thereof.

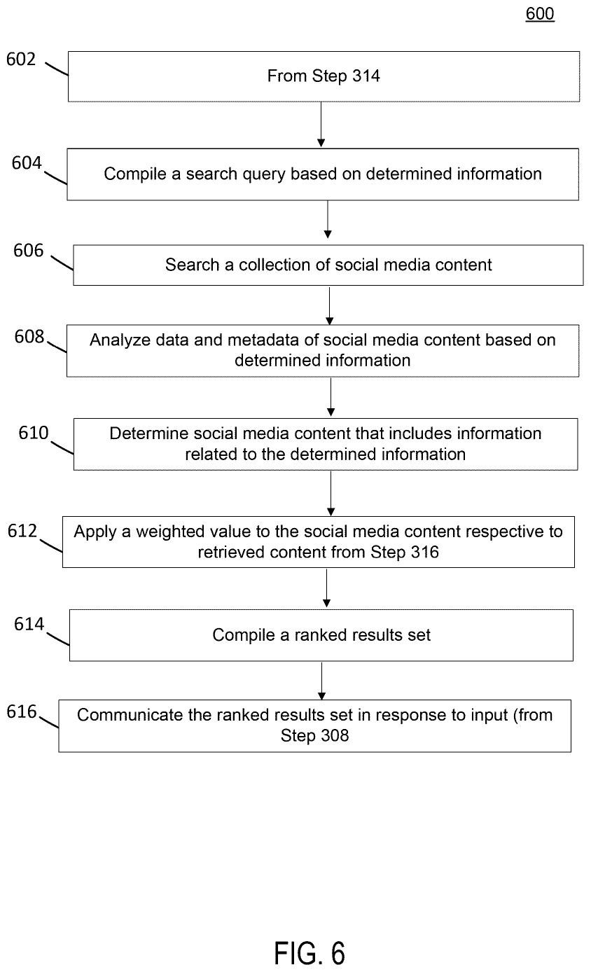

In some embodiments, engine 200 can connect to multiple databases and information sources, enabling comprehensive information retrieval about identified entities. Such sources may include, but are not limited to, public figure databases for person identification, geographic and landmark databases for location information, product catalogs and e-commerce platforms for item identification, social media platforms (e.g., as discussed infra in relation to FIG. 6), news sources for current context, user-specific databases for personalized information, and the like, or some combination thereof. Effectively, embodiments exist where engine 200 can search any publicly available database and/or database for which a subscription can be obtained to research and collect information related to such entities detected within the frame(s) of the video.

In Step 318, upon the information retrieval in Step 316, engine 200 can compile the retrieved content as an output, for which, in Step 320, can be communicated to a device and/or account of the user(s) (e.g., the requesting user, each user detected in Step 304, or the user identified in the input (e.g., “share with Bob”), or some combination thereof).

In some embodiments, upon performing Step 320, engine 200 can recursively proceed back to Step 308 (for further monitoring for inputs) and/or Step 302 to determine if the user desires to change the channel/feed (such that another video may be displayed).

By way of non-limiting example, the communication in Step 320 can include, but is not limited to, a depiction or reproduction of the captured frame(s) from the video, a live rendering of the video, a listing of the entities, a listing of the retrieved content (e.g., URLs, for example) related to each entity in the list of entities, advertisements related to each entity and/or each third party of the provided retrieved content (e.g., URLs), and the like. In some embodiments, the communication can further include functionality for, but not be limited to, sharing, posting to a social media page or site, downloading, uploading, and the like, the content and information depicted within the display of the communication, as discussed herein.

According to some embodiments, engine 200 can implement information compilation functionality that can organize and structure the retrieved content (for the entities in the frame) for optimal presentation to a user(s). Such compilation process can be based on, but not limited to, user preferences, device capabilities, delivery context to format the information appropriately, and the like, or some combination thereof. In some embodiments, engine 200 can generates multiple versions of the compiled information to support different output methods and user preferences (e.g., display on the TV screen by modifying the screen to depict a UI portion that visibly provides the entity information as an interactive set of IOS, and additionally send a notification to an account of an application of the user, where the notification, upon opened on the user's smart phone, displays similar information as within the UI, for example).

Accordingly, in some embodiments, engine 200 can provide multiple output modalities for delivering compiled entity information to users. For example, in some embodiments, engine 200 can provide functionality for display screen integration, which can include, but is not limited to, overlay information directly on the video playback screen, picture-in-picture (PIP) information displays, split-screen presentations with interactive elements, transparent overlays with gesture-based interaction, and the like, or some combination thereof.

In another non-limiting example, according to some embodiments, engine 200 can provide functionality for application integration, which can include, but is not limited to, native application interfaces with custom styling, widget-based information displays, interactive notification systems, virtual and/or augmented reality overlays, and the like, or some combination thereof.

In another non-limiting example, according to some embodiments, engine 200 can provide functionality for electronic messaging, which can include, but is not limited to, formatted email messages with rich media content, text messages with embedded links and previews, push notifications with interactive elements, in-app messaging with sharing capabilities, and the like, or some combination thereof.

In another non-limiting example, according to some embodiments, engine 200 can provide functionality for social sharing, which can include but is not limited to, direct person-to-person sharing through various platforms, group sharing with customized content formatting, social media integration for broader distribution, collaborative viewing features with shared annotations, and the like, or some combination thereof.

According to some embodiments, as discussed above, engine 200 can implement commerce integration operations in relation to the identified products and items. Such commerce functionality can include components that include product identification linking, which can include, but not be limited to, direct links to product pages on e-commerce platforms, price comparison across multiple retailers, availability tracking and notifications, alternative product recommendations, and the like.

In some embodiments, such commerce functionality can further or alternatively include social commerce integration, which can include, but not be limited to, links to product-related social media content, user reviews and recommendations, influencer content featuring the product, community discussions and ratings, and the like, or some combination thereof.

In some embodiments, such commerce functionality can further or alternatively include second-hand market integration, which can include, but not be limited to, links to second-hand platforms selling similar items, price comparisons between new and used items, condition and availability information, local marketplace listings, and the like, or some combination thereof.

In some embodiments, such commerce functionality can further or alternatively include brand-specific integration (e.g., when the video content is identified as advertising material (such as a commercial or sponsored content)), which can include, but not be limited to, direct links to advertiser's product catalogs, brand-specific promotional content, related products from the same brand, special offers and promotions, and the like, or some combination thereof.

In some embodiments, such commerce functionality can further or alternatively include “look-alike” recommendations (identify and suggest similar items), which can include, but not be limited to, visual similarity to identified items, functional equivalence, price range and availability equivalence, and the like, or some combination thereof, which can be based on user preferences and behavior patterns, for example. Such equivalence can be associated with or based on a threshold similarity value based on an AI/ML similarity analysis.

According to some embodiments, engine 200 can implement protocols to optimize (e.g., improve speed, computational efficiency and/or accuracy) the processing of Process 300, discussed supra, and Processes 400-700, discussed infra, which can include, but are not limited to, AI/ML models that adapt to user interaction patterns, content caching and preprocessing mechanisms, automated system maintenance and updates, and the like. Further, engine 200 can implement privacy and security measures throughout all aspects of the disclosed operations, which can include, but are not limited to, user data encryption and protection, configurable privacy settings for different features, secure information sharing protocols, compliance with relevant data protection regulations, and the like, or some combination thereof.

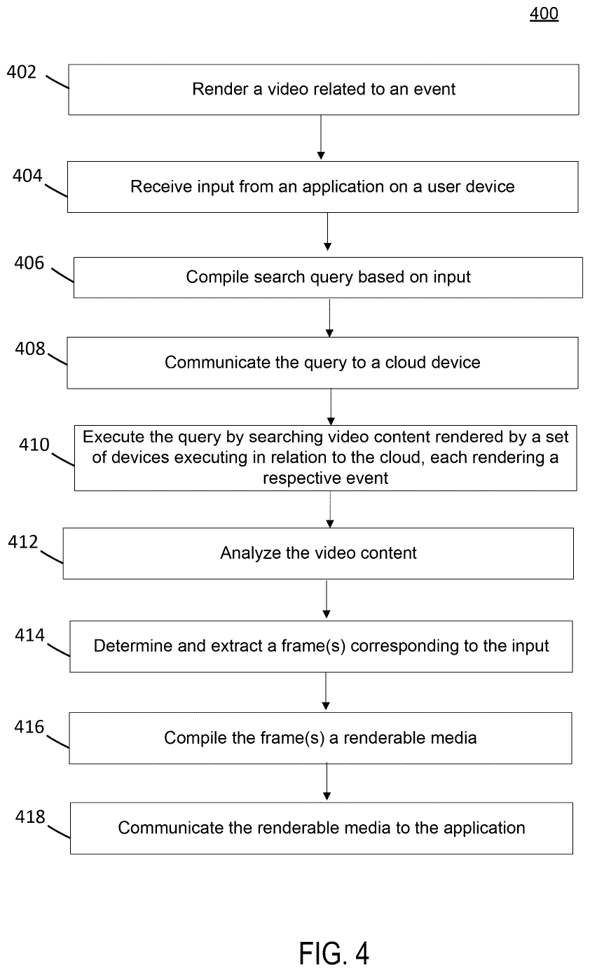

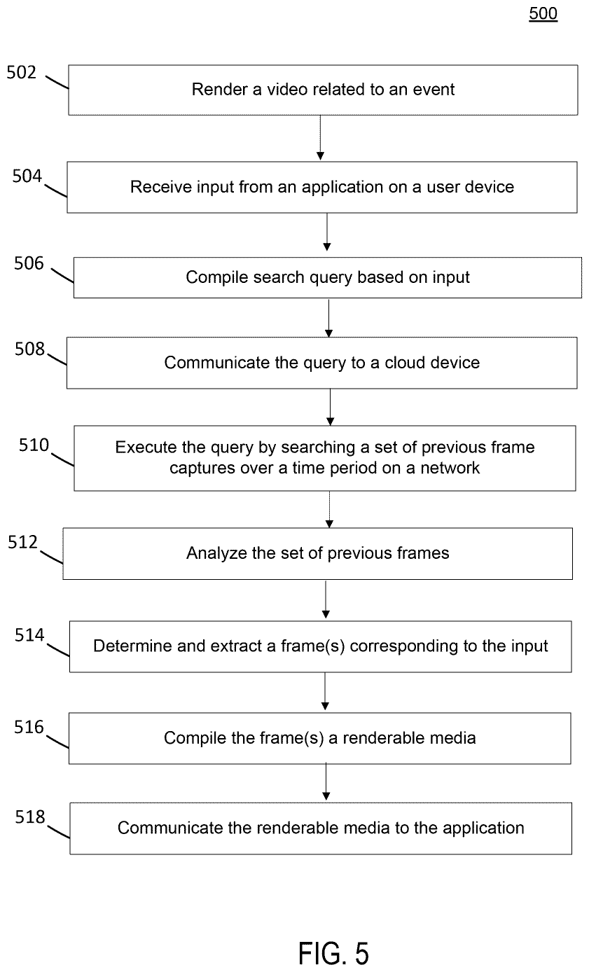

Turning to FIG. 4, Process 400 provides non-limiting example embodiments for performing frame(s) capture by a user when they are not at their home (or location for which their account is set up). For example, in Process 300, as discussed above, the user is a resident of their home for which the TV (or STB) is set up running their account; however, in Process 400 discussed herein (and Process 500 of FIG. 5, discussed infra), the user is not at home (e.g., in a public space, such as an airport, for example), and the TV/STB rendering the video on the TV is not an associated account/affiliated with the user's application account. Therefore, specific mechanisms are performed by engine 200 to provide the user with functionality for performing frame captures and entity discovery from rendered video in a public space. This, as evidenced from the discussion herein, evidences the applicability of the disclosed systems and methods beyond specific/designed locations, and across all real-world environments for which video content is being rendered and/or viewed.

According to some embodiments, Step 402 of Process 400 can be performed by rendering module 202 of content engine 200; Steps 404-408 can be performed by input module 204; Steps 410 and 412 can be performed by analysis module 206; Step 414 can be performed by determination module 208; and Steps 416-418 can be performed by output module 210.

According to some embodiments, Process 400 begins with Step 402 where engine 200 can cause the rendering of a video related to an event. The event, for example, is a live-sports event, for which video content is being rendered via a TV/STB.

In Step 404, engine 200 can receive input from an application on a user device. The input can be provided and received in a similar manner as discussed in relation to Step 308 in Process 300, discussed supra. In some embodiments, the input can be provided via an application executing on a user's device (e.g., installed and running and/or a web-based application, as discussed above).

By way of a non-limiting example, according to some embodiments, as a user is walking through the airport and as they pass by a television, which is playing a basketball game between the Golden State Warriors and New York Knicks, player S. Curry makes a 3 point shot. The user would like to view that play again; therefore, the user opens a proprietary application of engine 200 on their device and provides input related to that event. For example, the user can point his phone at the TV/STB and select a feature that enables the application to derive information from the TV/STB (e.g., via infrared, NFC and/or Bluetooth technology, for example). In another example, a listing of live sport events can be displayed within an application interface, whereby the user can select that game and input criteria as to the S. Curry play.

In Step 406, engine 200 can operate to compile a search query based on the input. The query can include information related to, but not limited to, a user identifier (ID), game ID, application ID, account ID, timestamp, location, TV ID, STB ID, and the like, or some combination thereof.

In Step 408, engine 200 can communicate the query for execution such that a frame or frame(s) of the play (e.g., S. Curry shot) can be identified and provided to the user. In some embodiments, engine 200 can cause communication of the query from the user's device (via the application executing thereon) to a cloud device. In Step 410, upon the cloud device receiving the query request, engine 200 can cause the search query to be executed.

According to some embodiments, the cloud (or cloud device(s), as discussed herein), can include a connection to a server(s) that is coupled to or connected to a set of devices (UEs, such as a set of STBs, for example) that are each currently streaming a set of sporting events (e.g., all or those currently available live sporting events being played on television). In some embodiments, the cloud can be directly connected, the cloud device(s), to the set of devices.

In some embodiments, reference to “all live sporting events” can correspond to, but not be limited to, major league sports, televised games, a region, time period, and the like, or some combination thereof. Therefore, for example, each device in the set of devices can be rendering a specific game, whereby a quantity of the devices that the cloud/server connects to is at least an amount that can support such rendering.

By way of non-limiting example, given the above user's presence in a United States airport, “all live streaming games” can correspond to all games currently being played on cable or satellite television for the 4 major sports (e.g., basketball, baseball, football and hockey). However, one of skill in the art would recognize that additional sports, sport leagues and television providers can be contemplated without departing from the scope of the instant disclosure.

In some embodiments, each of the set of devices can be rendering and performing their own frame captures, which can be performed according to a criteria (e.g., per k second or each scoring play, for example). In some embodiments, the rendering of the games by each device in the set of devices can be buffered so that should a request come in, a search or executed capture can be performed therefrom in real-time.

Thus, in Step 408, engine 200 can execute the query by searching video content being rendered by the set of devices in relation to the cloud, where each device in the set of devices is rendering its own specific event that is currently being played on a television broadcast or channel (e.g., across at least one television provider).

As a result of Step 408, the device within the set of devices that is rendering the specific game the user provided input about can be identified, for which the video content can also be identified. In some embodiments, the video content can be filtered down based on the search query, whereby a timestamp or time range for the content can be identified to focus on a specific action or person or item within the event, for example. Thus, in Step 412, engine 200 can analyze such video content based on the search query, whereby such analysis can be performed via the AI/ML and/or LLM techniques discussed above.

In Step 414, engine 200 can determine and extract a frame or set of frames from the video content based on the input. Such determination is based on the AI/ML and/or LLM techniques executed in Step 412, and can be performed in a similar manner as discussed above respective to Step 314 of Process 300. Accordingly, for example, continuing with the above example, the image frames from the video that relate to S. Curry catching a pass, shooting the 3-pointer and making such shot can be extracted from the video content.

In some embodiments, such extracted frames can then be processed via the processing of Steps 312-320, discussed above. For example, entity information related to the player S. Curry, the location, San Francisco, CA (e.g., the location of the game) and links to where the user can purchase S. Curry's jersey can be provided to the user (e.g., via their app). And, in some embodiments, such processing can enable discovery of statistics for the game, specific players, teams, and the like (e.g., team information, player information, player statistics for the season, in-game player statistics, and the like). Thus, in some embodiments, processing can proceed from Step 414 to Step 312-320 of Process 300 to provide entity discovery for the live event in real-time or on-demand.

Continuing with Process 400, which can also (or alternatively) be performed, processing from Step 414 can proceed to Step 416, where engine 200 can compile the extracted frames into a renderable media item, object or file. For example, the extracted frames of the S. Curry shot can be converted into a Graphics Interchange Format (GIF), a short-form video feature (e.g., Instagram® reel, for example), a “slow motion replay,” and/or any other type of known or to be known video clip, multi-media and/or renderable file. In some embodiments, the compilation can cause the extracted frames to be presented as separate image files, which can be based on the input received from the user (in Step 404) and/or based on the user's context, which can be determined via the AI/ML analysis discussed above. For example, engine 200 can determine that the user prefers the highlights in a certain format based on their past behavior; therefore, engine 200 can compile the format of the media in a specific format that matches the format of the user's preferred or past behavior.

And, in Step 418, engine 200 can communicate the renderable media to the application of the user (or an account of the user with the application). Such communication can be performed in a similar manner as discussed in relation to Step 320 of Process 300, discussed infra. For example, an electronic message can be generated, whereby it can be sent as an in-app notification to the application for the user to select and open, which will then display the renderable media.

Turning to FIG. 5, Process 500 provides further non-limiting example embodiments for performing frame(s) capture by a user when they are not at their home (or location for which their account is set up). For example, Process 400 discussed above, the user is not at home (e.g., in a public space, such as an airport, for example), yet in Process 500, the user is at a location for which the UE (e.g., STB or smart TV) is on the same network for which their UE is (e.g., and, where their account can be co-located, or an associated account/affiliated with the user's application account). Therefore, in a similar manner as discussed above in relation to FIG. 4, Process 500 provides specific mechanisms for engine 200 to provide the user with functionality for performing frame captures and entity discovery from rendered video in a public space.

According to some embodiments, Step 502 of Process 500 can be performed by rendering module 202 of content engine 200; Steps 504-508 can be performed by input module 204; Steps 510 and 512 can be performed by analysis module 206; Step 514 can be performed by determination module 208; and Steps 516-518 can be performed by output module 210.

According to some embodiments, Process 500 begins with Step 502 where engine 200 can cause a rendering of a video for an event. Such event, as discussed above, can be related to a live sporting event being played on another UE (e.g., smart TV or STB). For example, Process 500 operates in connection with a user being at another location (e.g., public space or location that is not their home or where they account is affiliated (e.g., office)), where the UE rendering the video is on the same network (e.g., ISP) as the user's account (e.g., they are both subscribers of network provider X). For example, a user goes to their neighbor's house to watch the Super Bowl™.

Accordingly, processing of Steps 504-508 of Process 500 can proceed in a similar manner as the operations of Steps 404-408 of Process 400, discussed supra.

In Step 510, engine 200 can execute the query by searching a set of previous frame captures of a time period on the network. For example, for previously extracted or captured frames from the video from n time (of k locations/users) on the ISP/CSP.

Accordingly, as discussed above, each UE (smart TV/STB) can save the captured frames (e.g., from buffering, back-end processing of serially performing captures to improve the capture processing by having cached captures for analysis upon receiving user input, and/or previous/other user captures of the same or related content, or some combination thereof) in a storage (e.g., database 108), which is accessible to engine 200 for searching for content from the video that corresponds to the received input.

In Step 512, engine 200 can analyze such video content (e.g., stored video and/or video frames for the live sporting event of the event in Step 502) based on the search query, whereby such analysis can be performed via the AI/ML and/or LLM techniques discussed above.

In Step 514, engine 200 can determine and extract a frame or set of frames from the video content based on the input. Such frames can involve a new extraction operation, or in some embodiments, retrieval of an already extracted frame set (e.g., that matches, at least a threshold level, the input of the user via their app). In some embodiments, such determination can be based on the AI/ML and/or LLM techniques discussed above—for example, engine 200 can execute an AI/ML and/or LLM model on the video/frames based on the input, and extract such frames as discussed herein. Accordingly, for example, continuing with the Super Bowl example, if a user requested to see the half-time show, rather than waiting for it to populate on a public form (e.g., YouTube®, for example), the user can provide such input via their app, whereby the image frames from the video that relate to halftime show (e.g., a frame quantity spanning the entirety of the halftime show, for example: 15 minutes, for example) can be extracted from the video content.

In some embodiments, such extracted frames can then be processed via the processing of Steps 312-320, discussed above. Thus, for example, the entity information related to the entertainers, their location, clothing, albums (from the audio) can be processed for presentation to the user as discussed supra. Thus, in some embodiments, processing can proceed from Step 514 to Step 312-320 of Process 300 to provide entity discovery for the live event in real-time or on-demand.

Continuing with Process 500, which can also (or alternatively) be performed, processing from Step 514 can proceed to Step 516, where engine 200 can compile the extracted frames into a renderable media item, object or file. Such processing can be performed in a similar manner as discussed above at least in relation to Step 416 of Process 400.

And, in Step 518, engine 200 can communicate the renderable media to the application of the user (or an account of the user with the application). Such communication can be performed in a similar manner as discussed in relation to Step 320 of Process 300, discussed infra. For example, an electronic message can be generated, whereby it can be sent as an in-app notification to the application for the user to select and open, which will then display the renderable media.

Turning to FIG. 6, Process 600 discloses systems and methods for mechanisms of the disclosed framework to leverage social-economics of the virility of content related to specific items.

By way of background, viral content has emerged as a powerful tool for product marketing, offering both economic efficiencies and technical advantages in reaching target audiences. At its core, viral marketing through influencer content leverages network effects and social proof to amplify brand messages at a fraction of traditional advertising costs.

From an economic perspective, viral content provides exceptional return on investment (ROI) compared to conventional marketing channels. While producing high-quality influencer content may require initial investment, the organic sharing mechanics mean brands can reach millions of potential customers without paying for additional distribution. This earned media approach significantly reduces customer acquisition costs. Furthermore, influencers often bring built-in audiences who trust their recommendations, reducing the friction and marketing spend typically needed to build credibility with new customers.

The technical architecture of social platforms actively encourages content virality through algorithmic amplification. When videos or posts generate high engagement metrics (e.g., likes, comments, shares, and the like), platform algorithms automatically increase their visibility in feeds, creating a self-reinforcing cycle of exposure. Modern social platforms also offer sophisticated targeting capabilities, allowing brands to seed viral content to highly specific demographic and psychographic segments most likely to respond and share.

Viral influencer content can be effective because it leverages multiple psychological triggers simultaneously. The parasocial relationships followers develop with influencers create trust and authenticity that traditional advertising struggles to achieve. When influencers demonstrate products in an organic, lifestyle-integrated way, it feels more like a recommendation from a friend than a sales pitch. This authentic presentation style also makes the content more likely to be shared, as users feel they're sharing useful information rather than advertisements.

The data and analytics capabilities available through social platforms provide another technical advantage. Brands can track precise engagement metrics, audience demographics, and conversion data in real-time, allowing for rapid optimization of content strategy. This data-driven approach enables brands to identify which influencer partnerships and content styles drive the strongest results, creating a feedback loop for continuous improvement.

Modern viral marketing also benefits from multi-platform synergy. Content can be optimized for different platforms (e.g., TikTok™, Instagram®, YouTube®, for example), while maintaining consistent messaging, creating multiple potential viral vectors. Cross-platform posting increases the chances of achieving viral lift while also reaching different demographic segments where they naturally spend time. Accordingly, the rise of social commerce features provides an additional technical benefit by reducing friction in the purchase journey. When viral content includes direct shopping integrations, viewers can move from discovery to purchase in a single session, improving conversion rates. This seamless integration of content and commerce represents a significant advantage over traditional marketing approaches that require multiple touchpoints to drive sales.

To that end, Process 600 provides embodiments for leveraging viral content to drive the entity information to the requesting user (e.g., referred to as “Influencer to Consumer”).

According to some embodiments, Process 600 can involve the processing of Steps 302-314 of Process 300, discussed supra, whereby Step 602 of Process 600 begins from Step 314 (as indicated in FIG. 6 (e.g., Steps 302-314 of Process 300 are performed in “Step 602”).

In Step 604, engine 200 can compile a search query based on the determination information (from the captured frame(s), as discussed above).

In Step 606, engine 200 can perform a search of a collection of social media content. As discussed above, such search can be based on an AI/ML analysis that results in a determination that the user would be more interested in (form their past behaviors and/or preferences, for example) retrieved content from social media influencers. For example, such influencers may provide indications of how an actual product works while displaying/engaging with the product—a real-world review, for example. Therefore, engine 200 can select a social platform(s) and/or storage location(s) for which such social videos may be located to perform such search.

According to some embodiments, as discussed herein, product tracking within social media content has evolved into a sophisticated system that combines technical tagging mechanisms with AI-driven recognition capabilities. For example, social media platforms can enable manual tagging where content creators can explicitly link products through embedded metadata, creating clickable and/or hoverable elements within their videos. Such tags typically include, for example, product identifiers, pricing information, and direct links to purchase pages.

More advanced solutions employ computer vision and object recognition algorithms to automatically identify products within video frames. Such technology can detect, for example, logos, specific product models, and even similar items, creating a searchable index of products appearing in social media content. Some platforms have developed proprietary scanning technologies that can analyze video content in real-time, mapping timestamps to specific product appearances and generating interactive overlays that viewers can engage with.

Modern social commerce platforms have integrated these capabilities directly into their infrastructure, allowing seamless tracking of product mentions and appearances across multiple creator videos. This integration enables brands to monitor not just when and where their products appear, but also the context of their presentation and the resulting engagement metrics.

Accordingly, the disclosed framework's operation, via engine 200, as in Step 606 and Steps 608-612 discussed infra, can leverage such tracking and analytics functionality that can correlate product appearances with engagement spikes, helping brands understand which presentation styles and creator partnerships drive the strongest results. As discussed herein, such product tracking capabilities are particularly valuable for attribution modeling, as platforms can now trace the customer journey from initial product view in creator content through to final purchase, providing concrete ROI measurements for influencer partnerships. Moreover, in some embodiments, such functionality can also enable dynamic pricing and inventory updates, ensuring that product links remain current even when viewing older content.

Thus, in Step 606, engine 200 can search for viral content that digitally depicts and discusses at least one entity depicted in the captured frame. For example, as discussed above, the frame can capture a motorcycle; and the searched and identified viral video or videos can be a user's review of the exact motorcycle. In some embodiments, the search can identify a set of videos related to the entity information (e.g., at least the product), for which a filtering can be performed to find the most similar to the product in the frame and/or desired by the user (e.g., based on similarity analysis via AI-ML models and/or user data (discussed above), respectively).

In Step 608, engine 200 can analyze the data and metadata (e.g., tags, for example) of the social media content, which can be based on the determined information (and/or user data, discussed above). Such analysis can be performed via engine 200 executing any of the AI/ML and/or LLM techniques discussed above on the identified social media content (or viral video). The data and/or metadata can relate to, but not be limited to, item ID, user ID, influencer ID, time, date, location, reviews, quality of reviews (e.g., what did reviewers say and/or number of stars, which can be analyzed via the LLM model(s), for example), the audio/text in the video (e.g., what is the influencer saying, which can be subject to an LLM-based analysis, for example), and the like, or some combination thereof.

In Step 610, based on the analysis in Step 608, engine 200 can determine the social media content that includes information related to the determined information. In some embodiments, this can involve selecting the video from a set of social videos that were identified as being related to the entity information. In some embodiments, the determination in Step 610 can involve determining what was provided in the social video that relates to the product in the frame (e.g., was it a positive review, negative review, what type of feedback was given, where to purchase, and the like).

In Step 612, engine 200 can determine and apply a weighted value to the social media content. Such weight can reflect how it compares to other product entity information that will be displayed, as discussed above. For example, continuing with the motorcycle example, when providing the output, as discussed above, links to where the motorcycle can be purchased (at the brand store or local reseller) can be provided, as well as the social media video. In some embodiments, the order and/or configuration of how such links/content can be provided can be based on the determined weight of the social view. For example, in some embodiments, when engine 200, via AI/ML based analysis of the determined social content (e.g., via Step 610), determines that the video is helpful to the user, then it can be ranked higher than the purchase links, and vice versa for when a review is not-deemed helpful. For example, if a review recommends to not purchase a motorcycle, then this may be placed atop the list of links so that the user is aware of a negative review/feedback before purchasing.

Accordingly, in Step 614, engine 200 can compile a ranked listing of a results set, which can correspond to how the entity information is displayed, as discussed above at least in relation to Step 318 of Process 300. And, in Step 616, engine 200 can communicate the ranked results set to the user (which is in response to the input from Step 308, as discussed above). Such communication can be performed in a similar manner as discussed above respective to Step 320 of Process 300.

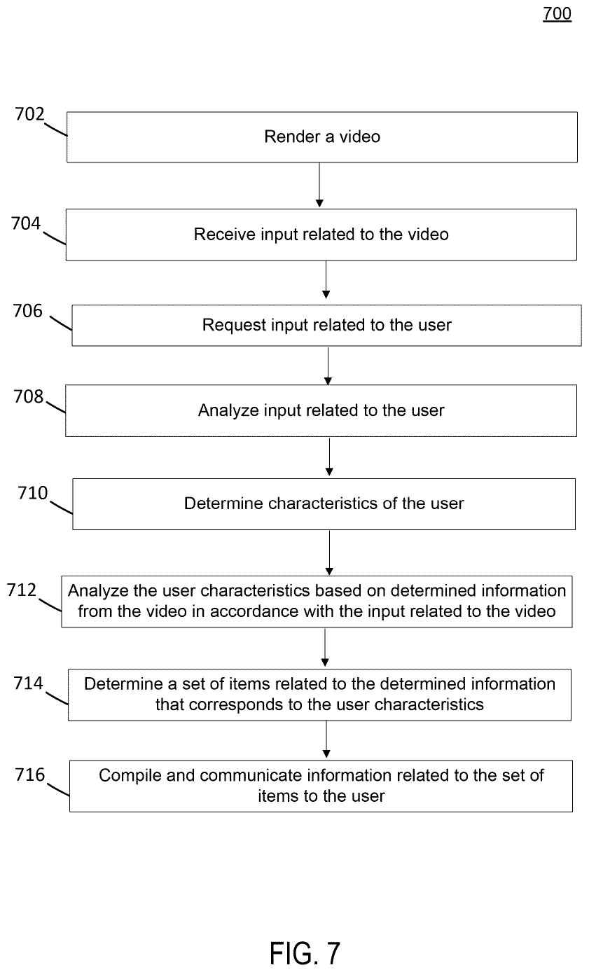

Turning to FIG. 7, Process 700 provides embodiments for interactive fashion recommendation functionality that offers users a seamless way to engage with clothing items they discover while watching television content. This innovative framework bridges the gap between passive content consumption and active shopping experiences by combining advanced computer vision, AI/ML, and real-time visualization technologies to create a highly personalized shopping experience.

As discussed herein, by way of example, according to some embodiments, when a user spots a desirable clothing item on their television screen, they can initiate an interaction with the TV/STB, as discussed above, where, via engine 200, a frame(s) of the video content can be captured, highlighting the selected garment and providing initial information about the item, including brand, basic style characteristics, and price range. Based on such frame(s) and the corresponding information derived from the digital information within and/or associated with the frame, engine 200 can provide a visual experience as to, but not limited to, how the item may look on the user, related items, product links for the item and/or related items, and the like, as discussed herein. Accordingly, the operations of Process 700 can provide a unique, computer-based shopping experience for a user, which currently does not exist within any e-commerce platform or application.

According to some embodiments, Step 702 of Process 700 can be performed by rendering module 202 of content engine 200; Steps 704-710 can be performed by input module 204; Step 712 can be performed by analysis module 206; Step 714 can be performed by determination module 208; and Step 716 can be performed by output module 210.

According to some embodiments, Process 700 begins with Step 702 where engine 200 can cause a rendering of a video on a UE (e.g., smart TV/STB, as discussed herein), which is performed in a similar manner as discussed above.

In Step 704, engine 200 can provide input related to the video, which can be performed in a similar manner as discussed above (e.g., as per the operations of Step 308 of Process 300 discussed supra). For example, when a user identifies an item of interest, users can interact through voice commands utilizing NLP, gesture recognition via integrated camera systems, companion mobile applications, traditional remote controls, or smart TV touch interfaces.

Accordingly, Step 704 can include the performance, as sub-steps of Step 704, Steps 310-316 of Process 300 to determine the entity information of the item. For example, such entity information can include, but is not limited to, product links, locations to purchase, size chart, color values, pattern analysis, fabric composition predictions, cut and style details, fit characteristics, brand information when available, and the like. Such data can be characterized by engine 200 as the determined entity information for which it can be used to “fit” to the user's projected image and/or characteristics, as discussed infra.

In Step 706, upon receiving the input related to the video, engine 200 can request input related to the user. Such request can be provided to the user, which can be in the form of, but not limited to, a message, voice command, haptic feedback, image capture via a camera associated with the TV/STB, image capture via a camera of the user's personal device, a search query of a repository of images of the user, a search query of a repository of user data (as discussed above), and the like, or some combination thereof.

In response to the request, the user can provide the requested input, which can be analyzed, as in Step 708. Such analysis can be performed via any of the AI/ML and/or LLM techniques discussed above.

By way of a non-limiting example, in some embodiments, an item captured in the frame via the input by the user is a sports coat by Ralph Lauren®. Engine 200 can request a picture of input corresponding to the upper body, frontal and/or entire body of the user to determine if/how the sports coat will fit the user. For example, such picture of the user can be used in accordance with retrieved specifics of the sports coat to determine how it will fit, whether the user should buy the item (via a provided product link(s), as discussed above) and/or which size to purchase.

According to some embodiments, users can provide physical characteristics through text entry, including height, weight, detailed body measurements, general body shape classification, and the like. In some embodiments, either in the alternative or as an additional input, engine 200 can capture such user information through various imaging technologies, from simple guided photo capture through a mobile device to integration with advanced three-dimensional (3D) body scanning systems or smart mirror technology.

Thus, in Step 710, based on the analysis in Step 708, engine 200 can determine the characteristics of the user, which can correspond to how the item may or may not fit, as discussed herein.

According to some embodiments, engine 200 employs sophisticated analysis algorithms to process the characteristics information across multiple dimensions. For example, physical analysis includes complex body measurement calculations, proportion analysis and detailed body shape classification. When image data is available, engine 200 can perform multi-angle body reconstruction, creating precise measurements and identifying key characteristics that might impact clothing fit and style appropriateness.

In some embodiments, engine 200's analysis can incorporate preference processing, thereby generating a comprehensive style profile that includes color palette determination, fit preference mapping, budget range classification, and the like, which can be stored in the precision profile for the user, as discussed above. Indeed, in some embodiments, such analysis leverages both explicit user inputs and implicit preferences derived from interaction patterns and historical data when available.

Accordingly, in some embodiments, in Step 710, engine 200 can generate a highly detailed digital avatar that serves as the foundation for visualization and fitting recommendations. Such avatar goes beyond simple body shape representation, incorporating accurate measurements, realistic skin tone and texture rendering, natural posture characteristics, and even dynamic movement capabilities. The avatar generation process involves engine 200 executing advanced 3D modeling techniques to ensure realistic representation across different clothing types and styles Therefore, in some embodiments, the data input phase in Step 704-710 can involve collecting comprehensive information beyond basic measurements, including demographic data such as age and gender identity, style preferences, typical price ranges, and preferred retailers. Indeed, such data collection processing in Steps 704-710 are designed to be both thorough and efficient, with intelligent defaults and progressive disclosure of more detailed options.

Continuing with Process 700, in Step 712, engine 200 can analyze the user characteristics (from Step 710, which can include the avatar) based on the determined information (entity information, as in Step 704, discussed supra). Such analysis can be performed via any of the AI/ML and/or LLM techniques, as discussed above.

According to some embodiments, engine 200 can perform a comprehensive compatibility analysis between the user's characteristics and the identified item. Such analysis can include computerized/algorithmically determinations related to fit calculations that consider both static measurements and dynamic movement requirements. Engine 200 can operate to evaluate style compatibility through proportion analysis, color harmony with the user's complexion, pattern scale appropriateness, and the like. Engine 200's analysis can further incorporate technical considerations that include fabric behavior predictions and maintenance requirements based on the user's lifestyle inputs, among others.

In Step 714, engine 200 can determine a set of items related to the determined (entity) information that corresponds to the user characteristics. According to some embodiments, engine 200 can generate a curated selection of recommended items. Such selection can include, for example, the exact identified item when available, along with size-specific recommendations across different brands.

According to some embodiments, engine 200 can identify similar items that may better suit the user's characteristics while maintaining the desired style elements. For example, this can include variations in cut that better flatter the user's body type, similar styles at different price points, or season-appropriate alternatives.

According to some embodiments, engine 200's fashion recommendation functionality can provide complementary items, recommend complete outfit suggestions, and the like, or some combination thereof. Such recommendations can be based on the user's existing wardrobe, user data, behaviors, lifestyle requirements, current fashion trends while remaining true to the user's personal style preferences and practical constraints, and the like.

And, in Step 716, engine 200 can compile and communicate information related to the set of items to the user. In some embodiments, the communication can be provided in a similar manner as discussed above in relation to Step 320 of Process 300, whereby the set of items, which can include a display on the avatar of the user, can be included in such message, UI, notification, and the like.

In some embodiments, the set of items may only include the item when the AI/ML and/or LLM model determines that the item “fits well” (e.g., the items specifications fit, at least to a threshold level, to the user characteristics, for example).

Accordingly, in some embodiments, Step 716 can involve compiling and presenting the set of items information in an engaging and actionable format. For example, in some embodiments, engine 200 can generate high-quality visualizations showing the user's avatar wearing each recommended item, providing multiple angle views and even movement demonstrations to show how garments will look in real-world situations. Such visualizations incorporate advanced fabric physics to accurately represent how different materials will drape and move on the user's body type.

In some embodiments, shopping information can be presented alongside visualizations, including direct purchase links, real-time pricing and availability information, size-specific inventory status across multiple retailers, detailed shipping and return policy information, and the like. In some embodiments, engine 200 can provide comprehensive product specifications, care instructions, and user reviews when available, along with style advice for wearing and accessorizing each item.

In some embodiments, engine 200 can provide interactive features that provide capabilities for users to explore variations in color and size, with engine 200 updating visualizations in real-time to reflect such changes. In some embodiments, social integration features can provide users with capabilities to share potential purchases with friends or fashion communities for feedback, and even connect with professional stylists for additional guidance.

According to some embodiments, the disclosed framework, throughout the processing of the steps of Process 700, can execute AI/ML capabilities that continuously refine recommendations based on user interactions, purchase decisions and feedback. Such learning leverages both individual user patterns and aggregate data across user segments to improve recommendation accuracy over time.

Accordingly, engine 200's operations of Processes 300-700, discussed above, are performed with minimal latency, employing edge computing techniques (e.g., executing at or in connection with the TV/STB, for example) and efficient algorithms to ensure a smooth and engaging user experience from initial content viewing through to engagement with the entity information output. Such technical architecture enables the framework to process complex computer-executable instructions, and generate sophisticated outputs and visualizations, while maintaining responsive interaction and real-time updates to recommendations and entity information of the content being rendered and captured.

FIG. 10 is a schematic diagram illustrating a client device showing an example embodiment of a client device that may be used within the present disclosure. Client device 1000 may include many more or less components than those shown in FIG. 10. However, the components shown are sufficient to disclose an illustrative embodiment for implementing the present disclosure. Client device 1000 may represent, for example, UE 102 discussed above at least in relation to FIG. 1.

As shown in the figure, in some embodiments, Client device 1000 includes a processing unit (CPU) 1022 in communication with a mass memory 1030 via a bus 1024. Client device 1000 also includes a power supply 1026, one or more network interfaces 1050, an audio interface 1052, a display 1054, a keypad 1056, an illuminator 1058, an input/output interface 1060, a haptic interface 1062, an optional global positioning systems (GPS) receiver 1064 and a camera(s) or other optical, thermal or electromagnetic sensors 1066. Device 1000 can include one camera/sensor 1066, or a plurality of cameras/sensors 1066, as understood by those of skill in the art. Power supply 1026 provides power to Client device 1000.

Client device 1000 may optionally communicate with a base station (not shown), or directly with another computing device. In some embodiments, network interface 1050 is sometimes known as a transceiver, transceiving device, or network interface card (NIC).

Audio interface 1052 is arranged to produce and receive audio signals such as the sound of a human voice in some embodiments. Display 1054 may be a liquid crystal display (LCD), gas plasma, light emitting diode (LED), or any other type of display used with a computing device. Display 1054 may also include a touch sensitive screen arranged to receive input from an object such as a stylus or a digit from a human hand.

Keypad 1056 may include any input device arranged to receive input from a user. Illuminator 1058 may provide a status indication and/or provide light.

Client device 1000 also includes input/output interface 1060 for communicating with external. Input/output interface 1060 can utilize one or more communication technologies, such as USB, infrared, Bluetooth™, or the like in some embodiments. Haptic interface 1062 is arranged to provide tactile feedback to a user of the client device.

Optional GPS transceiver 1064 can determine the physical coordinates of Client device 1000 on the surface of the Earth, which typically outputs a location as latitude and longitude values. GPS transceiver 1064 can also employ other geo-positioning mechanisms, including, but not limited to, triangulation, assisted GPS (AGPS), E-OTD, CI, SAI, ETA, BSS or the like, to further determine the physical location of client device 1000 on the surface of the Earth. In one embodiment, however, Client device 1000 may through other components, provide other information that may be employed to determine a physical location of the device, including for example, a MAC address, Internet Protocol (IP) address, or the like.

Mass memory 1030 includes a RAM 1032, a ROM 1034, and other storage means. Mass memory 1030 illustrates another example of computer storage media for storage of information such as computer readable instructions, data structures, program modules or other data. Mass memory 1030 stores a basic input/output system (“BIOS”) 1040 for controlling low-level operation of Client device 1000. The mass memory also stores an operating system 1041 for controlling the operation of Client device 1000.

Memory 1030 further includes one or more data stores, which can be utilized by Client device 1000 to store, among other things, applications 1042 and/or other information or data. For example, data stores may be employed to store information that describes various capabilities of Client device 1000. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 1000.

Applications 1042 may include computer executable instructions which, when executed by Client device 1000, transmit, receive, and/or otherwise process audio, video, images, and enable telecommunication with a server and/or another user of another client device. Applications 1042 may further include a client that is configured to send, to receive, and/or to otherwise process gaming, goods/services and/or other forms of data, messages and content hosted and provided by the platform associated with engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:

Aspect 1. A method comprising:
rendering, by a device, a video, the video corresponding to a program broadcast over a network, the video being viewed by a user;
receiving, by the device, during the rendering of the video, input from a second device, the input comprising a request to capture a frame of the video, the frame of the video corresponding to a time proximate to a time the input is received;
analyzing, by the device, the frame of the video based on user data associated with the user; determining, by the device, based on the analysis, entity information, the entity information corresponding to a category of entities digitally depicted within the frame of the video;
retrieving, by the device, over a network, content related to the entity information; and
communicating, by the device, to an account of the user, an output comprising the entity information and related retrieved content.

Aspect 2. The method of aspect 1, further comprising:
compiling the retrieved content as an electronic output, the compilation comprising configuring the entity information for each identified entity in a manner that enables interaction with the retrieved content that respective relates to such identified entity.

Aspect 3. The method of aspect 2, further comprising the electronic output being selected from a group consisting of: an electronic message, in-app notification, user interface (UI), visualization and augmented reality display.

Aspect 4. The method of aspect 1, further comprising the category of entities being people, places and items, such that entities within such categories are identified and provided via the output.

Aspect 5. The method of aspect 1, further comprising the retrieved content comprising network resources related to each entity, each network resource being sourced from a location that corresponds to an interest as indicated by the user data.

Aspect 6. The method of aspect 1, further comprising:
determining that the user is viewing the video during the rendering; and
identifying the user data for the user based on the determination that the user is viewing the video, the user data comprising at least one of preferences or patterns of activity for the user.

Aspect 7. The method of aspect 6, further comprising:
performing network analysis to determine the user is present in a location where the device is rendering the video;
performing occupancy sensing operations to determine the user is present in the location; and
performing the determination that the user is viewing the video during the rendering based on at least one of the network analysis or occupancy sensing operations.

Aspect 8. The method of aspect 1, further comprising:
searching, based on the user data, a collection of social media videos, each social media video comprising tags that correspond to particular products depicted therein;
analyzing the collection based on the entity information; and identifying a social media video that corresponds to the entity information, such that the social media video is provided as part of the output communicated to the account of the user.

Aspect 9. The method of aspect 1, further comprising:
compiling a visualization of the user, the visualization involving a display of an item within the frame in relation to a physical characteristics of the user; and
communicating the output further comprising the compiled visualization.

Aspect 10. The method of aspect 1, further comprising the input corresponding to a set of frames.

Aspect 11. The method of aspect 1, further comprising the device being a smart television.

Aspect 12. The method of aspect 1, further comprising the device being a set to box (STB) connected to a television.

Aspect 13. The method of aspect 1, further comprising the second device being a remote control or user device, the user device executing an application enabling the input to be provided to the device.

Aspect 14. The method of aspect 1, further comprising the input being provided directly to the device by a user, the input comprising voice or gesture commands.

Aspect 15. The method of aspect 1, further comprising the program being a sports event, live-event, television show or a movie.

Aspect 16. A method comprising:
rendering, by an application executing on a device, a video, the video corresponding to a live event broadcast;
receiving, by the application, during the rendering of the video, input from an application on a user device, the input comprising a request to capture entity information from at least one frame of the video;
causing, by application, a search to be communicated to a cloud device, the cloud device connected in association with a set of devices rendering a plurality of live events;
analyzing, by the application, via the search, video content from each of the plurality of live events;
determining, by the application, based on the analysis, a set of frames from video content from a live event rendered by a device of the set of devices that corresponds to the event of the video, the set of frames comprising digital content corresponding to the entity information; and
communicating, by the application, to the application on the user device, the set of frames as renderable media.

Aspect 17. The method of aspect 16, further comprising the plurality of live events encompassing each live event capable of being broadcast at the time of the input.

Aspect 18. The method of aspect 16, further comprising the set of devices being a set of set top boxes (STBs).

Aspect 19. A method comprising:
rendering, by an application executing on a device, a video, the video corresponding to a live event broadcast;
receiving, by the application, during the rendering of the video, input from an application on a user device, the input comprising a request to capture entity information from at least one frame of the video;
causing, by application, a search to be communicated to a cloud device, the cloud device comprising a repository of previous frame captures for a time period on a network;
analyzing, by the application, via the search, the previous frame captures based on the entity information;
determining, by the application, based on the analysis, a set of frames from an identified frame capture, the set of frames comprising digital content corresponding to the entity information; and
communicating, by the application, to the application on the user device, the set of frames as renderable media.

Aspect 20. The method of aspect 19, further comprising the network being an internet service provider (ISP) that provides services to a location of the device and the user, the user not being associated with the location.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
rendering, by an application associated with a device, a video related to a live event;
receiving, by the application, during the rendering of the video, a request from a user related to at least one frame of the video;
analyzing, by the application, another rendering of the video by another device;
determining, by the application, based on the analysis of the other rendering of the video, the at least one frame of the video from the other rendering; and
communicating, by the application, an output based on the determined at least one other frame from the video from the other rendering to a device of the user in response to the request.

2. The method of claim 1, further comprising:
causing, by the application, a search to be communicated to a cloud device, the cloud device connected in association with a set of devices rendering a plurality of live events;
analyzing, by the application, via the search, video content for each of the plurality of live events; and
determining, by the application, based on the analysis, a set of frames from video content from a live event rendered by a device of the set of devices that corresponds to the live event of the video.

3. The method of claim 2, further comprising the communicated output to the user device comprising the determined set of frames.

4. The method of claim 1, further comprising the request comprising an indication to capture a highlight from the video.

5. The method of claim 4, further comprising:
compiling the at least one frame into a renderable media file, such that the communicated output to the user device comprises the renderable media file.

6. The method of claim 1, further comprising the request comprising an indication to capture entity information from within the at least one frame of the video, the entity information corresponding to at least a portion of entities depicted within the at least one frame.

7. The method of claim 6, further comprising the entities depicted within the at least one frame being at least one of a real-world entity or digital entity.

8. The method of claim 6, further comprising:
performing the analysis of the other rendering of the video based on data associated with the user;
determining, by the application, based on the analysis, the entity information from the other rendering;
retrieving, by the application, over a network, content related to the entity information; and
communicating, by the application, the output to include the entity information and related retrieved content.

9. The method of claim 1, further comprising the request being provided by the user device, the user device being a separate device from a device executing the application.

10. The method of claim 1, further comprising the live event being one of a plurality of live events encompassing each live event capable of being broadcast at the time of the request.

11. A system comprising:
a processor configured to:
render, by an application, a video related to a live event;
receive, by the application, during the rendering of the video, a request from a user related to at least one frame of the video;
analyze, by the application, another rendering of the video by another device;
determine, by the application, based on the analysis of the other rendering of the video, the at least one frame of the video from the other rendering; and
communicate, by the application, an output based on the determined at least one other frame from the video from the other rendering to a device of the user in response to the request.

12. The system of claim 11, wherein the processor is further configured to:
cause, by the application, a search to be communicated to a cloud device, the cloud device connected in association with a set of devices rendering a plurality of live events;
analyze, by the application, via the search, video content for each of the plurality of live events; and
determine, by the application, based on the analysis, a set of frames from video content from a live event rendered by a device of the set of devices that corresponds to the live event of the video, wherein the communicated output to the user device comprising the determined set of frames.

13. The system of claim 11, wherein the processor is further configured such that the request comprises an indication to capture a highlight from the video, such that the processor is further configured to:
compile the at least one frame into a renderable media file, such that the communicated output to the user device comprises the renderable media file.

14. The system of claim 11, wherein the processor is further configured such that the request comprises an indication to capture entity information from within the at least one frame of the video, the entity information corresponding to at least a portion of entities depicted within the at least one frame.

15. The system of claim 14, wherein the processor is further configured to:
perform the analysis of the other rendering of the video based on data associated with the user;
determine, by the application, based on the analysis, the entity information from the other rendering;
retrieve, by the application, over a network, content related to the entity information; and
communicate, by the application, the output to include the entity information and related retrieved content.

16. The system of claim 11, wherein the processor is further configured such that the request is provided by the user device, the user device being a separate device from a device executing the application.

17. The system of claim 11, wherein the processor is further configured such that the live event is one of a plurality of live events encompassing each live event capable of being broadcast at the time of the request.

18. A non-transitory computer-readable storage medium tangibly encoded with computer-executable instructions, that when executed by a device, perform a method comprising:
rendering, by an application associated with the device, a video related to a live event;
receiving, by the application, during the rendering of the video, a request from a user related to at least one frame of the video;
analyzing, by the application, another rendering of the video by another device;
determining, by the application, based on the analysis of the other rendering of the video, the at least one frame of the video from the other rendering; and
communicating, by the application, an output based on the determined at least one other frame from the video from the other rendering to a device of the user in response to the request.

19. The non-transitory computer-readable storage medium of claim 18, further comprising:
causing, by the application, a search to be communicated to a cloud device, the cloud device connected in association with a set of devices rendering a plurality of live events;
analyzing, by the application, via the search, video content for each of the plurality of live events; and
determining, by the application, based on the analysis, a set of frames from video content from a live event rendered by a device of the set of devices that corresponds to the live event of the video.

20. The non-transitory computer-readable storage medium of claim 18, further comprising:
performing the analysis of the other rendering of the video based on data associated with the user;
determining, by the application, based on the analysis, the entity information from the other rendering;
retrieving, by the application, over a network, content related to the entity information; and
communicating, by the application, the output to include the entity information and related retrieved content.
